(19) United States
(12) Patent Application Publication
(10) Pub. No.: US 2026/0011108 A1
(43) Pub. Date: Jan. 8, 2026

(54) INFORMATION PROCESSING APPARATUS, INFORMATION PROCESSING METHOD, AND NON-TRANSITORY COMPUTER READABLE MEDIUM

(71) Applicant: NEC Corporation, Tokyo (JP)

(72) Inventors: Taichi OHTSUJI, Tokyo (JP); Taro ABE, Tokyo (JP)

(73) Assignee: NEC Corporation, Tokyo (JP)

(21) Appl. No.: 19/251,968

(22) Filed: Jun. 27, 2025

(30) Foreign Application Priority Data
Jul. 3, 2024 (JP) 2024-107283

(51) Int. Cl. G06V 10/25; G06T 3/40

(52) U.S. Cl. CPC G06V 10/25; G06T 3/40

(57) ABSTRACT

To appropriately generate teacher data for supervised machine learning. Provided is an information processing apparatus including: a generation unit that generates a spectrum image and a spectrogram image based on spectrum data of a received radio signal; a display unit that displays the spectrum image and the spectrogram image on a same screen, accepts designation of a specific range including a specific signal from a user on one of the spectrum image and the spectrogram image, superimposes and displays a first bounding box corresponding to the specific range on the spectrum image, and superimposes and displays a second bounding box corresponding to the specific range on the spectrogram image; and an output unit that outputs teacher data in which information indicating the specific range and specification information of the specific signal are used as ground truth data and the spectrum image is used as an explanatory variable.

### INCORPORATION BY REFERENCE

This application is based upon and claims the benefit of priority from Japanese patent application No. 2024-107283, filed on Jul. 3, 2024, the disclosure of which is incorporated herein in its entirety by reference.

### TECHNICAL FIELD

The present disclosure relates to an information processing apparatus, an information processing method, and a program.

### BACKGROUND ART

Patent Literature 1 discloses a technique for detecting a signal area by generating spectrum data based on a received radio signal, converting the spectrum data into a spectrum image, and inputting the spectrum image to a learned model.

### CITATION LIST

### Patent Literature

[Patent Literature 1] Japanese Unexamined Patent Application Publication No. 2023-55315

### SUMMARY

However, in Patent Literature 1, for example, a problem of preparing teacher data for supervised machine learning is not examined.

In view of the above-described problems, an example object of the present disclosure is to provide a technique capable of appropriately generating teacher data for supervised machine learning.

According to a first aspect of the present disclosure, there is provided an information processing apparatus including: a generation unit that generates a spectrum image and a spectrogram image based on spectrum data of a received radio signal; a display unit that displays the spectrum image and the spectrogram image on a same screen, accepts designation of a specific range including a specific signal from a user on one of the spectrum image and the spectrogram image, superimposes and displays a first bounding box corresponding to the specific range on the spectrum image, and superimposes and displays a second bounding box corresponding to the specific range on the spectrogram image; and an output unit that outputs teacher data in which information indicating the specific range and specification information of the specific signal are used as ground truth data and the spectrum image is used as an explanatory variable.

According to a second aspect of the present disclosure, there is provided an information processing method including: generating a spectrum image and a spectrogram image based on spectrum data of a received radio signal; displaying the spectrum image and the spectrogram image on a same screen; accepting designation of a specific range including a specific signal from a user on one of the spectrum image and the spectrogram image; superimposing and displaying a first bounding box corresponding to the specific range on the spectrum image, and superimposing and displaying a second bounding box corresponding to the specific range on the spectrogram image; and outputting teacher data in which information indicating the specific range and specification information of the specific signal are used as ground truth data and the spectrum image is used as an explanatory variable.

According to a third aspect of the present disclosure, there is provided a program for causing a computer to execute: generating a spectrum image and a spectrogram image based on spectrum data of a received radio signal; displaying the spectrum image and the spectrogram image on a same screen; accepting designation of a specific range including a specific signal from a user on one of the spectrum image and the spectrogram image; superimposing and displaying a first bounding box corresponding to the specific range on the spectrum image, and superimposing and displaying a second bounding box corresponding to the specific range on the spectrogram image; and outputting teacher data in which information indicating the specific range and specification information of the specific signal are used as ground truth data and the spectrum image is used as an explanatory variable.

According to one aspect, teacher data for supervised machine learning can be appropriately generated.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a diagram illustrating an example of a configuration of an information processing apparatus according to some example embodiments;

FIG. 2 is a diagram illustrating a configuration example of an information processing system according to some example embodiments;

FIG. 3 is a diagram illustrating a hardware configuration example of the information processing apparatus according to some example embodiments;

FIG. 4 is a flowchart illustrating an example of processing of the information processing apparatus according to some example embodiments;

FIG. 5 is a diagram illustrating an example of a display screen for displaying a spectrum image and a spectrogram image according to some example embodiments;

FIG. 6 is a diagram illustrating an example of an operation in a case where annotation work is accepted on the spectrum image according to some example embodiments;

FIG. 7 is a diagram illustrating an example of an operation in a case where annotation work is accepted on a spectrogram image according to some example embodiments;

FIG. 8 is a diagram illustrating an example of a histogram of power values of reception signals according to some example embodiments; and

FIG. 9 is a diagram illustrating an example of a method of determining a range in which a specific signal exists after determining a power value area in which the specific signal according to some example embodiments exists.

### EXAMPLE EMBODIMENT

The principles of the present disclosure will be described with reference to some example embodiments. It is to be understood that the example embodiments have been described for purposes of illustration only and will aid those skilled in the art in understanding and carrying out the present disclosure without suggesting limitations on the scope of the present disclosure. The disclosure described in the present description is implemented in various methods other than those described below.

In the following description and claims, unless defined otherwise, all technical and scientific terms used in the present specification have the same meaning as commonly understood by those skilled in the art of the technical field to which the present disclosure belongs.

Hereinafter, some example embodiments of the present disclosure will be described with reference to the drawings. Each of the drawings is merely an example to illustrate one or more example embodiments. Each of the drawings is not associated with only one specific example embodiment, but may be associated with one or more other example embodiments. As those skilled in the art will appreciate, various features or steps described with reference to any one of the drawings may be combined with features or steps illustrated in one or more other drawings, for example, to create an example embodiment that is not explicitly illustrated or described. All of the features or steps illustrated in any one of the drawings for describing some example embodiments are not necessarily mandatory, and some features or steps may be omitted. The order of the steps described in any of the drawings may be changed as appropriate.

### First Example Embodiment

### <Configuration>

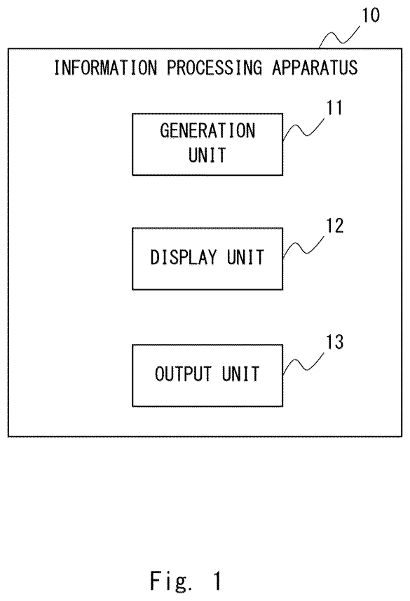

A configuration of an information processing apparatus 10 according to some example embodiments will be described with reference to FIG. 1. FIG. 1 is a diagram illustrating an example of a configuration of an information processing apparatus (teacher data generation apparatus) 10 according to some example embodiments. The information processing apparatus 10 includes a generation unit 11, a display unit 12, and an output unit 13. These units may be implemented by cooperation of one or more programs installed in the information processing apparatus 10 and hardware such as a processor and a memory of the information processing apparatus 10.

The generation unit 11 generates a spectrum image and a spectrogram image based on the spectrum data of the received radio signal.

The display unit 12 displays the spectrum image and the spectrogram image generated by the generation unit 11 on the same screen, and accepts designation of a specific range including a specific signal on one of the spectrum image and the spectrogram image from the user. Then, the display unit 12 superimposes and displays a first bounding box corresponding to the specific range on the spectrum image, and superimposes and displays a second bounding box corresponding to the specific range on the spectrogram image.

The output unit 13 outputs teacher data in which information indicating the specific range and specification information of the specific signal are used as ground truth data and a spectrum image is used as an explanatory variable.

### Second Example Embodiment

### <System Configuration>

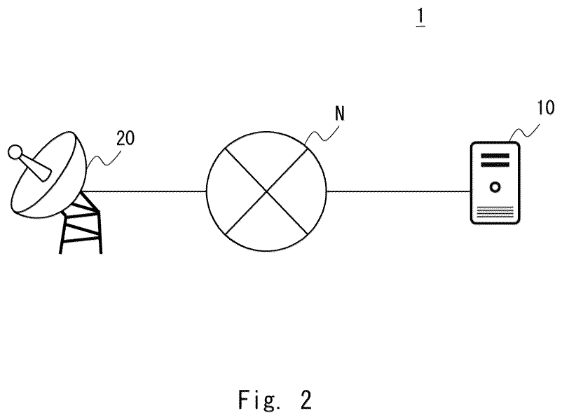

Next, a configuration of an information processing system 1 according to some example embodiments will be described with reference to FIG. 2. FIG. 2 is a diagram illustrating a configuration example of the information processing system 1 according to some example embodiments. In the example of FIG. 2, the information processing system 1 includes the information processing apparatus 10 and a reception apparatus 20. In the example of FIG. 2, the information processing apparatus 10 and the reception apparatus 20 are connected so as to be able to communicate with each other via a network N. The number of information processing apparatuses 10 and the number of reception apparatuses 20 are not limited to those in the example of FIG. 2.

Examples of the network N include the Internet, a mobile communication system, a wireless local area network (LAN), a LAN, and a bus. Examples of the mobile communication system include a fifth generation mobile communication system (5G), a sixth generation mobile communication system (6G and Beyond 5G), a fourth generation mobile communication system (4G), and a third generation mobile communication system (3G).

The information processing apparatus 10 is, for example, an apparatus such as a server, a cloud, a personal computer, or a smartphone. For example, the information processing apparatus 10 generates teacher data for supervised machine learning based on the annotation work of the user.

The reception apparatus 20 includes a radio wave sensor that receives various radio signals. The reception apparatus 20 transmits spectrum data generated by performing short-time Fourier transform (STFT) on the received radio signal data to the information processing apparatus 10.

### <Hardware Configuration>

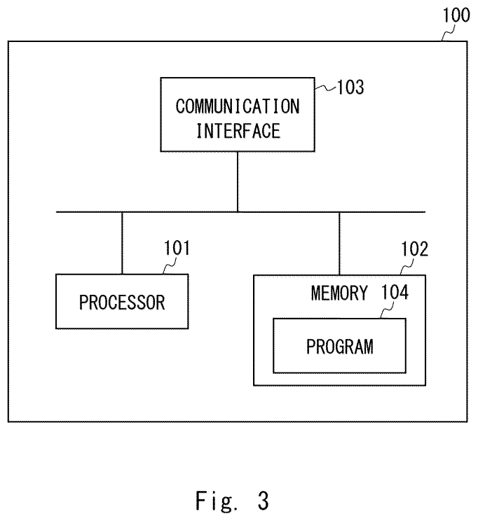

FIG. 3 is a diagram illustrating a hardware configuration example of the information processing apparatus 10 according to some example embodiments. In the example of FIG. 3, the information processing apparatus 10 (computer 100) includes a processor 101, a memory 102, and a communication interface 103. These units may be connected by a bus or the like. The memory 102 stores at least a part of a program 104. The communication interface 103 includes an interface necessary for communication with other network elements.

In a case where the program 104 is executed by the cooperation of the processor 101, the memory 102, and the like, at least a part of processing according to some example embodiments of the present disclosure is performed by the computer 100. The memory 102 may be of any type. The memory 102 may be a non-transitory computer-readable storage medium, as a non-limiting example. The memory 102 may also be implemented using any suitable data storage technique such as a semiconductor-based memory device, a magnetic memory device and system, an optical memory device and system, a fixed memory, or a removable memory. Although only one memory 102 is illustrated in the computer 100, there may be several physically different memory modules in the computer 100. The processor 101 may be of any type. The processor 101 may include one or more of a general purpose computer, a dedicated computer, a microprocessor, a digital signal processor (DSP), and a processor based on a multi-core processor architecture as a non-limiting example. The computer 100 may include a plurality of processors such as application specific integrated circuit chips that are temporally dependent on a clock that synchronizes the main processor.

Some embodiments of the present disclosure may be implemented in hardware or dedicated circuitry, software, logic, or any combination thereof. Some aspects may be implemented in hardware, while other aspects may be implemented in firmware or software that may be executed by a controller, a microprocessor or other computing devices.

The present disclosure also provides at least one computer program product tangibly stored on a non-transitory computer-readable storage medium. The computer program product includes computer-executable instructions, such as those included in a program module, and is executed on a device on a target real or virtual processor to perform the processes or methods of the present disclosure. The program module includes routines, programs, libraries, objects, classes, components, data structures, and the like that execute particular tasks or implement particular abstract data types. Functions of the program module may be combined or divided between the program modules as desired in some example embodiments. A machine-executable instruction of the program module can be executed in a local or distributed device. In the distributed device, the program modules can be located on both local and remote storage media.

Program codes for executing the methods of the present disclosure may be written in any combination of one or more programming languages. These program codes are provided to a processor or controller of a general purpose computer, a dedicated computer, or other programmable data processing apparatuses. In a case where the program code is executed by the processor or controller, the functions/operations in the flowcharts and/or the implemented block diagrams are performed. The program code is executed entirely on a machine, partially on the machine as a stand-alone software package, partially on the machine and partially on a remote machine, or entirely on the remote machine or server.

The program can be stored and supplied to the computer using various types of non-transitory computer-readable media. The non-transitory computer-readable medium includes various types of tangible recording media. Examples of the non-transitory computer-readable medium include a magnetic recording medium, a magneto-optical recording medium, an optical disc medium, and a semiconductor memory. Examples of the magnetic recording medium include a flexible disk, a magnetic tape, and a hard disk drive. Examples of the magneto-optical recording medium include a magneto-optical disk. Examples of the optical disc medium include a Blu-ray disc, a compact disc (CD)-read only memory (ROM), a CD-recordable (R), and a CD-rewritable (RW). Examples of the semiconductor memory include a solid state drive, a mask ROM, a programmable ROM (PROM), an erasable PROM (EPROM), a flash ROM, and a random access memory (RAM). The program may be supplied to the computer using various types of transitory computer-readable media. Examples of the transitory computer-readable media include electrical signals, optical signals, and electromagnetic waves. The transitory computer-readable media can supply the programs to the computer via a wired communication path such as an electric wire and an optical fiber or a wireless communication path.

### <Processing>

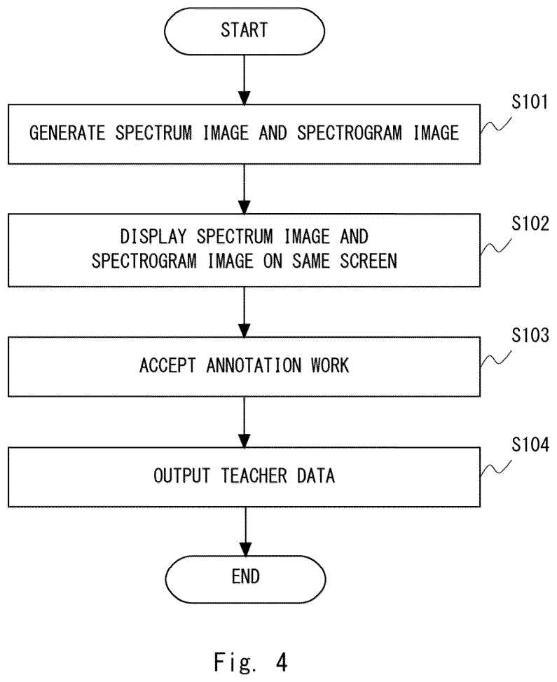

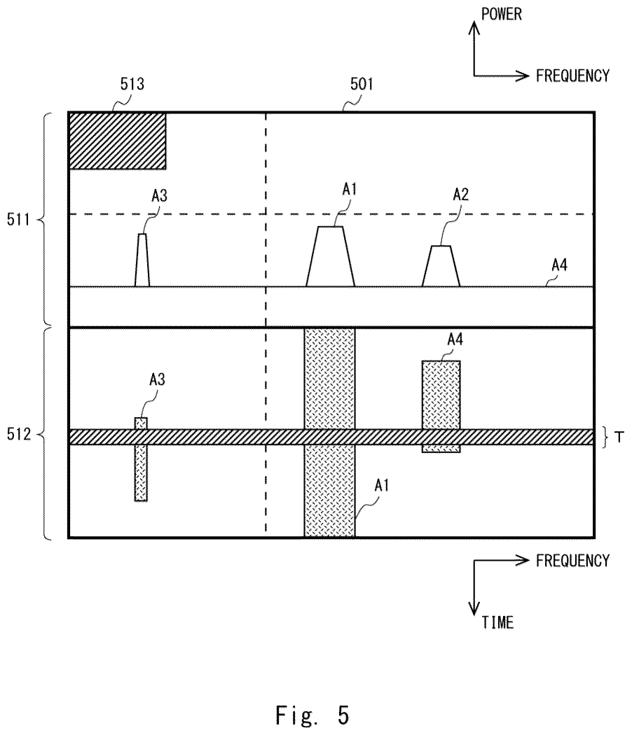

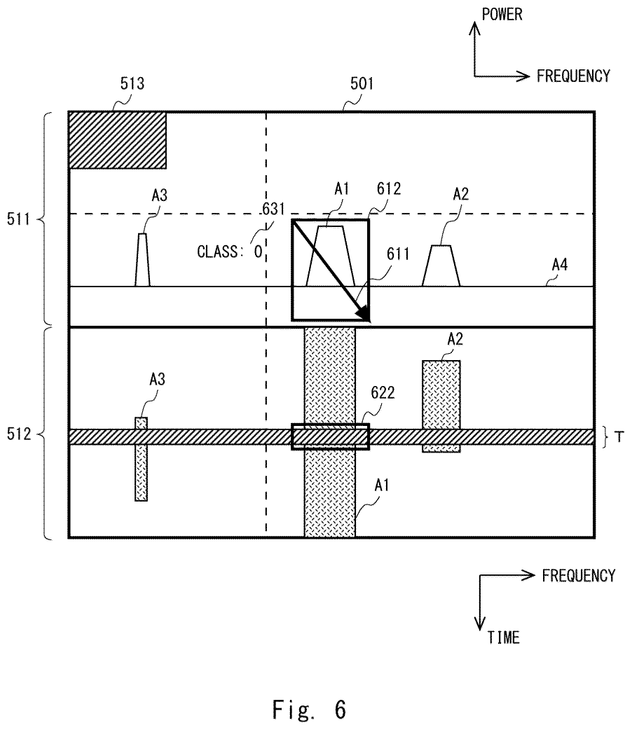

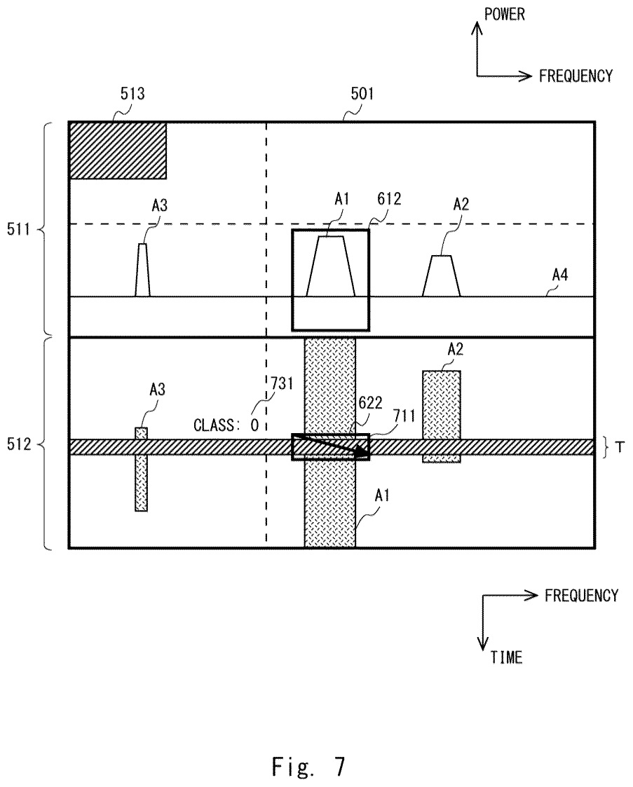

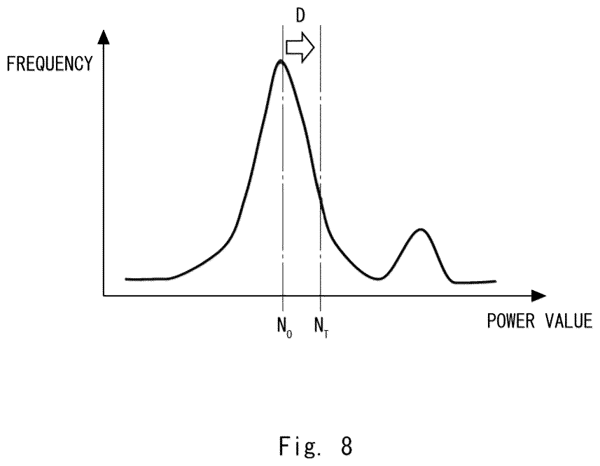

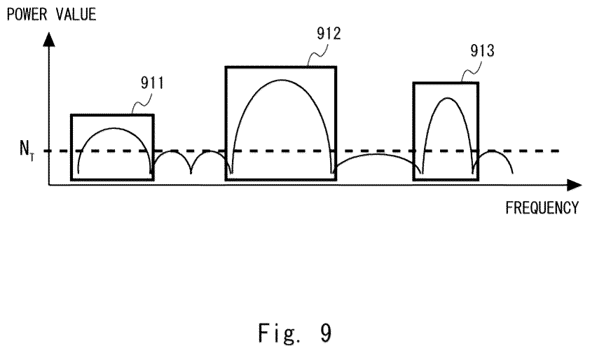

Next, an example of processing in the information processing apparatus 10 according to some embodiments will be described with reference to FIGS. 4 to 9. FIG. 4 is a flowchart illustrating an example of the processing of the information processing apparatus 10 according to some example embodiments. FIG. 5 is a diagram illustrating an example of a display screen for displaying a spectrum image and a spectrogram image according to some example embodiments. FIG. 6 is a diagram illustrating an example of an operation in a case where the annotation work is accepted on the spectrum image according to some example embodiments. FIG. 7 is a diagram illustrating an example of an operation in a case where the annotation work is accepted on the spectrogram image according to some example embodiments. FIG. 8 is a diagram illustrating an example of a histogram of power values of reception signals according to some example embodiments. FIG. 9 is a diagram illustrating an example of a method of determining a range in which the specific signal exists after the region of the power value in which the specific signal exists is determined according to some example embodiments. The processing of FIG. 4 may be executed, for example, in a case where a predetermined operation is performed by the user.

In step S101, the generation unit 11 generates a spectrum image and a spectrogram image based on the spectrum data of the radio signal received and recorded by the reception apparatus 20. Here, the spectrum data may be generated by performing short-time Fourier transform on the radio signal data received by the reception apparatus 20.

The spectrum image is obtained by visualizing a radio signal as a two-dimensional image of frequency and signal intensity, for example. In a region 511 of FIG. 5, a spectrum image in which a horizontal axis represents frequency and a vertical axis represents signal intensity (power) is displayed. The spectrum image may be generated by performing short-time Fourier transform illustrated in (Expression 1) on the reception signal received by the radio wave sensor and arranging the reception signals in the time direction. Here, x(t) is a reception signal, and w(t) is a window function. In (Expression 1), 1/(2π)^{1/2} may be multiplied as a coefficient other than the integral symbol.

$$\begin{matrix}[ Expression 1 ] & \\ {STFT}_{x , w} ( t , w ) = {\int }_{- ∞}^{∞} x ( τ ) w ( τ - t ) {e}^{- j ωτ} d τ & ( 1 )\end{matrix}$$

The spectrogram image is obtained by visualizing a radio signal in terms of time, frequency, and signal intensity, for example. In a region 512 of FIG. 5, a spectrogram image in which a horizontal axis represents frequency, a vertical axis represents time, and color or brightness represents signal intensity is displayed. A spectrogram image with a vertical axis as time looks like a waterfall, and thus is also called “waterfall”.

Subsequently, the display unit 12 displays the spectrum image and the spectrogram image generated by the generation unit 11 on the same screen as illustrated in FIG. 5 (step S102). In the example of FIG. 5, on a display screen 501, a spectrum image is displayed in the region 511, and a spectrogram image is displayed in the region 512.

In the spectrogram image of the region 512, a situation in which the signals A1 to A3 are continuously received for a specific time in the time direction is visualized. The spectrum image of the region 511 illustrates a situation in which signals A1 to A3 having different bandwidths are received at the specific time T designated by the user on the spectrogram image of the region 512. A horizontal line A4 below each signal simulatively indicates a noise floor. It is known that noise has randomness, and it should be noted that noise does not actually form a straight line segment like A4.

The display unit 12 may be configured to operate a cursor (cross-hair cursor) on the cross with a pointing device such as a mouse. In the example of FIG. 5, the display unit 12 displays a display region 513 so as to be superimposed on the spectrum image of the region 511. The display unit 12 may display the coordinates of the pixel pointed by the cross-hair cursor, the corresponding frequency, the received power level of the signal, and the like in the display region 513.

Subsequently, the display unit 12 accepts an operation (annotation work) for designating a specific range including a specific signal on the spectrum image or the spectrogram image from the user (step S103). Here, the display unit 12 may accept, for example, an operation of selecting each specific range considered to include one or more specific signals using an input device such as a mouse. The display unit 12 may accept an input operation of specification information of one or more specific signals using, for example, an input device such as a keyboard. The specification information may include, for example, individual information (for example, a transmitter name or the like) or model information of the transmitter that has transmitted the specific signal. The specification information may include, for example, attribute information such as a modulation scheme of a specific signal, a digital communication wave, an analog communication wave, a non-communication wave, or impulse noise. The specification information may include, for example, a class number used for deep learning.

The display unit 12 may superimpose and display the specific range designated by the user and the specification information of the specific signal included in the specific range on each of the spectrum image and the spectrogram image. In a case where the annotation work is performed on the spectrogram image, the display unit 12 may superimpose and display the range information only for the time selected by the user on the spectrogram image on the spectrum image.

(Example of Case where Annotation Work is Accepted on Spectrum Image)

An example of an operation by the user in a case where the annotation work is accepted on the spectrum image will be described with reference to FIG. 6. For example, the user operates (for example, drag as indicated by arrow 611) the cross-hair cursor on the region 511 (spectrum view) where the spectrum image is displayed, and designates a range (first bounding box) 612 that can surround the signal A1 as the specific signal. Then, the user inputs specification information of the specific signal using an input device (for example, a keyboard or a touch display). At this time, for example, the display unit 12 may pop up a specification information input screen on the screen.

Then, the display unit 12 may superimpose and display the first bounding box 612 designated by the user and the specification information 631 on the spectrum view. Then, the display unit 12 may superimpose and display a second bounding box 622 surrounding the signal A1, which is the specific signal designated by the user, in the region 512 (spectrogram view) where the spectrogram image is displayed. In this case, the display unit 12 may change the color of the frame line of the second bounding box 622 or color the inside of the second bounding box based on the specification information (for example, a class number or the like). Since the second bounding box 622 corresponding to the first bounding box 612 designated by the user is displayed not only on the spectrum view but also on the spectrogram view, the annotation work becomes easy.

(Example of Case where Annotation Work is Accepted on Spectrogram Image)

An example of an operation by the user in a case where the annotation work is accepted on the spectrogram image will be described with reference to FIG. 7. In this case, for example, the user operates (for example, drag as indicated by arrow 711) the cross-hair cursor on the spectrogram view 512 and designates a range (second bounding box) 622 that can surround the signal A1 as the specific signal. In this case, in the example of FIG. 5, only a portion corresponding to a specific time T is surrounded, but in a case where the specific signal is continuously transmitted in the time direction like a communication wave, an operation of selecting the entire signal may be performed.

Then, the user inputs specification information of the specific signal using an input device (for example, a keyboard or a touch display). At this time, for example, the display unit 12 may pop up a specification information input screen on the screen.

Then, the display unit 12 may superimpose and display the second bounding box 622 designated by the user and the specification information 731 on the spectrogram view 512. In this case, the display unit 12 may change the color of the frame line of the second bounding box 622 or color the inside of the second bounding box 622 based on the specification information (for example, a class number or the like).

Then, the display unit 12 may superimpose and display the first bounding box 612 surrounding the signal A1, which is a specific signal designated by the user, in the spectrum view 511. Since the spectrum is corresponding to a result obtained by cutting out a certain time of the spectrogram, a spectrogram image corresponding to the specific time T of the spectrogram view is displayed on the spectrum view. As described above, in the annotation work on the spectrum view, the annotation is performed only in one shot at a certain time. Then, since the annotation work on the spectrogram view is also reflected on the spectrogram side, the load of the annotation work is reduced.

Subsequently, the output unit 13 outputs data of a combination of the spectrum image and the ground truth data as teacher data (step S104). Here, the output unit 13 may set information indicating the specific range designated by the user and specification information of the specific signal as ground truth data. As a result, it is possible to generate a learned model for inferring the range including the specific signal and the specification information of the specific signal based on the spectrum image by machine learning using the teacher data.

The display unit 12 may accept, from the user on the display screen of FIG. 7, an operation of enlarging the second bounding box 622 enclosing the specific signal at the specific time T displayed on the spectrogram view 512 in the time direction of the spectrogram image. In this case, the display unit 12 may accept, from the user, an operation of expanding the range in the time direction by, for example, dragging an upper line segment of the second bounding box 622 in the upward direction or dragging a lower line segment in the downward direction. In this case, in the processing of step S104, the output unit 13 may output each piece of data of a combination of the spectrum image for each time bin (unit of specific time) included in the enlarged time range and the ground truth data as teacher data. In this case, for example, the output unit 13 may output first teacher data including a first spectrum image corresponding to a first time point included in the second bounding box expanded in the time direction and the ground truth data. Then, the output unit 13 may output, for example, second teacher data including a second spectrum image corresponding to a second time point included in the second bounding box enlarged in the time direction and the ground truth data.

As a result, for example, in a case where signals are continuously transmitted mainly in the time direction such as a communication wave, the load of the annotation work can be reduced. For example, the annotation work in the spectrum view 511 is reflected in the spectrogram view 512, and the annotation work for a plurality of pieces of teacher data can be collectively performed by an operation of expanding the range in the time direction in the spectrogram view 512.

### (Example of Estimating Specific Range Including Specific Signal)

In the above-described example, an example in which the user designates the specific range including the specific signal has been described. Alternatively or additionally, the display unit 12 may estimate a specific range including the specific signal. In this case, the display unit 12 may estimate the specific range based on the spectrum data and superimpose and display the first bounding box corresponding to the estimated specific range on the spectrum image. Then, the display unit 12 may superimpose and display the second bounding box corresponding to the estimated specific range on the spectrogram image. The reception signal may include a large number of signals to be detected. In this case, if the annotation work is manually performed for all the specific signals, the workload increases. Therefore, by estimating the specific range including the specific signal, the workload of the user can be reduced.

In this case, the display unit 12 may first calculate a power value for each frequency bin based on spectrum data of a radio signal received and recorded by the reception apparatus 20. In a case where the i-th frequency bin at the time t is Xᵢ(t), it is assumed that spectrum data is recorded in the form of a complex number as in Expression (2). In this case, the display unit 12 may calculate a reception power value Pᵢ(t) by Expression (3).

$$\begin{matrix}[ Expression 2 ] & \\ {X}_{i} ( t ) = {X}_{iI} ( t ) + {jX}_{iQ} ( t ) & ( 2 )\end{matrix}$$

$$\begin{matrix}[ Expression 3 ] & \\ {P}_{i} ( t ) = {X}_{iI}^{2} ( t ) + {X}_{iQ}^{2} ( t ) & ( 3 )\end{matrix}$$

Then, the display unit 12 may generate a histogram of power values. FIG. 8 illustrates an example of a histogram of power values of reception signals according to some example embodiments. In a case where the signal band being received is not congested, the frequency (reception frequency) of the power value corresponding to the background noise near the noise floor becomes high. In this case, as illustrated in FIG. 8, the power level of the specific signal to be detected and the power level of the noise are separated on the histogram. In a case where a power value at which the frequency value is maximized is No and a value obtained by adding a predetermined value D (margin) is NT, a region where the power value is NT or more can be considered as a region of the power value where the specific signal exists, and a region where the power value is less than NT can be considered as a region where the background noise exists.

Therefore, the display unit 12 may estimate a range in which the power value of the bin continuously exceeds NT in the frequency direction on the spectrum image as a range in which the specific signal exists.

FIG. 9 illustrates an example of a method of determining a range in which the specific signal exists after determining the region of the power value in which the specific signal exists according to some example embodiments. As illustrated in FIG. 9, each of the regions 911 to 913 including not only the region where the power value of each bin exceeds NT but also margins of a predetermined number of bins on both sides may be determined as the range in which the specific signal exists.

The display unit 12 may automatically set and display each bounding box (frame) on the spectrum image in each of one or more ranges in which the specific signal is estimated to exist. Then, the user checks each estimated bounding box. Then, the user may perform fine correction, deletion, or the like on each bounding box as appropriate. In a case where the user finds a specific signal that is not included in the automatic estimation, the user may set (add) a bounding box including the specific signal that is not included.

### (Example of Estimating Specific Range Including Specific Signal by Machine Learning)

The display unit 12 may estimate the specific range including the specific signal by machine learning based on the spectrum image and the learned model. In this case, the display unit 12 may detect the specific signal on the spectrum image by using a learned model generated by machine learning using a set of teacher data created based on a previously received radio signal. In this case, the display unit 12 may use, for example, semi-supervised learning particularly utilizing the idea of the bootstrap method. In this case, it is assumed that the teacher data set has been constructed at least once although the size is small.

### (Others)

In order to perform signal detection using deep learning, it is necessary to prepare teacher data for generating a learning model. Conventionally, teacher data is created by, for example, annotation work or the like in which a person manually designates a position (that is, coordinates) using application software. It is known that deep learning generally requires a large amount of teacher data, and it is desirable to be able to reduce labor (reduce load) for creating teacher data.

According to the present disclosure, for example, in order to reduce the load of the annotation work for generating the teacher data of the radio signal detection, the result of the annotation work on one of the spectrum image and the spectrogram image can be reflected on the other. Therefore, it is possible to reduce the load of the annotation work on the spectrum image of the radio signal for generating the teacher data.

### Modified Example

The information processing apparatus 10 may be an apparatus contained in one housing, but the information processing apparatus 10 of the present disclosure is not limited thereto. Each unit of the information processing apparatus 10 may be implemented by, for example, cloud computing including one or more computers. The information processing apparatus 10 and the reception apparatus 20 may be housed in the same housing and configured as an integrated information processing apparatus. At least a part of the processing of each functional unit of the information processing apparatus 10 may be executed by the reception apparatus 20. Such an information processing apparatus 10 is also included in an example of the “information processing apparatus” of the present disclosure.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Some or all of the above-described example embodiments may be described as the following supplementary notes, but are not limited to the following supplementary notes. Some or all of the elements (for example, configurations and functions) described in each supplementary note dependent on Supplementary Note 1 can also be dependent on independent supplementary notes of other categories by the same dependency relationship. Some or all of the elements described in any Supplementary Note may be applied to various types of hardware, software, recording means for recording software, systems, and methods.

### (Supplementary Note 1)

An information processing apparatus including:
a generation unit that generates a spectrum image and a spectrogram image based on spectrum data of a received radio signal;
a display unit that displays the spectrum image and the spectrogram image on a same screen, accepts designation of a specific range including a specific signal from a user on one of the spectrum image and the spectrogram image, superimposes and displays a first bounding box corresponding to the specific range on the spectrum image, and superimposes and displays a second bounding box corresponding to the specific range on the spectrogram image; and
an output unit that outputs teacher data in which information indicating the specific range and specification information of the specific signal are used as ground truth data and the spectrum image is used as an explanatory variable.

### (Supplementary Note 2)

The information processing apparatus according to Supplementary Note 1,
in which the display unit is configured to execute:
in a case where designation of the specific range is accepted on the spectrum image, superimposing and displaying the second bounding box corresponding to the specific range on the spectrogram image; and
in a case where designation of the specific range is accepted on the spectrogram image, superimposing and displaying a first bounding box corresponding to the specific range on the spectrum image.

### (Supplementary Note 3)

The information processing apparatus according to Supplementary Note 1, in which the display unit is configured to execute accepting an operation of enlarging the second bounding box in a time direction of the spectrogram image from the user.

### (Supplementary Note 4)

The information processing apparatus according to Supplementary Note 3, in which the output unit is configured to execute outputting first teacher data including a first spectrum image corresponding to a first time point included in the second bounding box expanded in the time direction and the ground truth data, and second teacher data including a second spectrum image corresponding to a second time point included in the second bounding box expanded in the time direction and the ground truth data.

### (Supplementary Note 5)

The information processing apparatus according to Supplementary Note 1 or 2, in which the display unit is configured to execute estimating the specific range based on the spectrum data, superimposing and displaying the first bounding box corresponding to the estimated specific range on the spectrum image, and superimposing and displaying the second bounding box corresponding to the estimated specific range on the spectrogram image.

### (Supplementary Note 6)

The information processing apparatus according to Supplementary Note 5, in which the display unit estimates the specific range based on reception power and a reception frequency of the received radio signal.

### (Supplementary Note 7)

The information processing apparatus according to Supplementary Note 5, in which the display unit estimates the specific range based on the spectrum image and a learned model.

### (Supplementary Note 8)

The information processing apparatus according to Supplementary Note 1 or 2, in which the specification information includes at least one of individual information or model information of a transmitter that transmits the specific signal, attribute information of the specific signal, and a class number used for deep learning.

### (Supplementary Note 9)

An information processing method including:
generating a spectrum image and a spectrogram image based on spectrum data of a received radio signal;
displaying the spectrum image and the spectrogram image on a same screen;
accepting designation of a specific range including a specific signal from a user on one of the spectrum image and the spectrogram image;
superimposing and displaying a first bounding box corresponding to the specific range on the spectrum image, and superimposing and displaying a second bounding box corresponding to the specific range on the spectrogram image; and
outputting teacher data in which information indicating the specific range and specification information of the specific signal are used as ground truth data and the spectrum image is used as an explanatory variable.

### (Supplementary Note 10)

A program for causing a computer to execute:
generating a spectrum image and a spectrogram image based on spectrum data of a received radio signal;
displaying the spectrum image and the spectrogram image on a same screen;
accepting designation of a specific range including a specific signal from a user on one of the spectrum image and the spectrogram image;
superimposing and displaying a first bounding box corresponding to the specific range on the spectrum image, and superimposing and displaying a second bounding box corresponding to the specific range on the spectrogram image; and
outputting teacher data in which information indicating the specific range and specification information of the specific signal are used as ground truth data and the spectrum image is used as an explanatory variable.

What is claimed is:

1. An information processing apparatus comprising:
a memory configured to store instructions; and
a processor configured to execute the instructions to:
generate a spectrum image and a spectrogram image based on spectrum data of a received radio signal;
display the spectrum image and the spectrogram image on a same screen;
accept designation of a specific range including a specific signal from a user on one of the spectrum image and the spectrogram image;
superimpose and display a first bounding box corresponding to the specific range on the spectrum image
superimpose and display a second bounding box corresponding to the specific range on the spectrogram image; and
output teacher data in which information indicating the specific range and specification information of the specific signal are used as ground truth data and the spectrum image is used as an explanatory variable.

2. The information processing apparatus according to claim 1,
wherein the processor is further configured to execute the instructions to:
in a case where designation of the specific range is accepted on the spectrum image, superimpose and display the second bounding box corresponding to the specific range on the spectrogram image; and
in a case where designation of the specific range is accepted on the spectrogram image, superimpose and display a first bounding box corresponding to the specific range on the spectrum image.

3. The information processing apparatus according to claim 1, wherein the processor is further configured to execute the instructions to accept an operation of enlarging the second bounding box in a time direction of the spectrogram image from the user.

4. The information processing apparatus according to claim 3, wherein the processor is further configured to execute the instructions to output first teacher data including a first spectrum image corresponding to a first time point included in the second bounding box expanded in the time direction and the ground truth data, and second teacher data including a second spectrum image corresponding to a second time point included in the second bounding box expanded in the time direction and the ground truth data.

5. The information processing apparatus according to claim 1, wherein the processor is further configured to execute the instructions to estimate the specific range based on the spectrum data, superimpose and display the first bounding box corresponding to the estimated specific range on the spectrum image, and superimpose and display the second bounding box corresponding to the estimated specific range on the spectrogram image.

6. The information processing apparatus according to claim 5, wherein the processor is further configured to execute the instructions to estimate the specific range based on received power and a reception frequency of the received radio signal.

7. The information processing apparatus according to claim 5, wherein the processor is further configured to execute the instructions to estimate the specific range based on the spectrum image and the learned model.

8. The information processing apparatus according to claim 1, wherein the specification information includes at least one of individual information or model information of a transmitter that transmits the specific signal, attribute information of the specific signal, and a class number used for deep learning.

9. An information processing method comprising:
generating a spectrum image and a spectrogram image based on spectrum data of a received radio signal;
displaying the spectrum image and the spectrogram image on a same screen;
accepting designation of a specific range including a specific signal from a user on one of the spectrum image and the spectrogram image;
superimposing and displaying a first bounding box corresponding to the specific range on the spectrum image, and superimposing and displaying a second bounding box corresponding to the specific range on the spectrogram image; and
outputting teacher data in which information indicating the specific range and specification information of the specific signal are used as ground truth data and the spectrum image is used as an explanatory variable.

10. A non-transitory computer-readable medium storing a program for causing a computer to execute:
generating a spectrum image and a spectrogram image based on spectrum data of a received radio signal;
displaying the spectrum image and the spectrogram image on a same screen;
accepting designation of a specific range including a specific signal from a user on one of the spectrum image and the spectrogram image;
superimposing and displaying a first bounding box corresponding to the specific range on the spectrum image, and superimposing and displaying a second bounding box corresponding to the specific range on the spectrogram image; and
outputting teacher data in which information indicating the specific range and specification information of the specific signal are used as ground truth data and the spectrum image is used as an explanatory variable.
